(19) United States
(12) Patent Application Publication
(10) Pub. No.: US 2026/0141284 A1
(43) Pub. Date: May 21, 2026

(54) TRAINED MODEL GENERATION METHOD, DETERMINATION DEVICE, DETERMINATION METHOD, AND PROGRAM

(71) Applicant: Kabushiki Kaisha Kobe Seiko Sho (Kobe Steel, Ltd.), Kobe-shi (JP)

(72) Inventors: Tetsuo TANAKA, Kobe-shi (JP); Tsuyoshi ASHIDA, Kobe-shi, Hyogo (JP)

(73) Assignee: Kabushiki Kaisha Kobe Seiko Sho (Kobe Steel, Ltd.), Kobe-shi (JP)

(21) Appl. No.: 18/879,315

(22) PCT Filed: Jul. 31, 2023
(86) PCT No.: PCT/JP2023/027975

§ 371 Date: Dec. 27, 2024

(30) Foreign Application Priority Data
Aug. 8, 2022 (JP) 2022-126088
Nov. 15, 2022 (JP) 2022-182474

(51) Int. Cl. G06N 20/00

(52) U.S. Cl. CPC G06N 20/00

(57) ABSTRACT

A trained model generation method is a method for generating a trained model for binary classification, the method comprising: setting, as a hyperparameter, at least one of a weighting parameter or a determination threshold for determining whether the data is positive or negative, the weighting parameter weighting one error in a loss function obtained by adding together an error when training data is positive and an error when the training data is negative more heavily than the other error; performing machine learning on a learning model using the loss function so as to output a probability at which the training data is positive or negative; and searching for the hyperparameter so that at least one of a false positive rate or a false negative rate is equal to or less than a predetermined value.

### TECHNICAL FIELD

The present disclosure relates to a method for generating a trained model, a determination device, a determination method, and a program.

### BACKGROUND ART

Patent Document 1 discloses a technology for training a variational autoencoder using a plurality of object images as training data so as to reduce the error between the input and output and to output the mean, variance, and higher-order statistics of a distribution approximated by a specific distribution for each unit pixel.

### PRIOR ART DOCUMENT

### Patent Document

Patent Document 1: JP 2021-144314 A

### SUMMARY OF INVENTION

### Problems to be Solved by Invention

A trained model for binary classification may be used in inspections to determine whether a product is pass or fail. In binary classification, not only true positives (TP) and true negatives (TN) but also false positives (FP) and false negatives (FN) can occur (see FIG. 2).

A false positive (FP) is classifying a negative (fail) as positive (pass). The false positive rate (FPR) is expressed as FP/(FP+TN). A false negative (FN) is classifying a positive (pass) as negative (fail). The false negative rate (FNR) is expressed as FN/(FN+TP).

In the inspection to determine whether a product is acceptable or not, it is required to reduce the false positive rate (FPR) to guarantee quality. However, since a conventional learning model is trained to increase the accuracy rate (TP+TN)/(TP+TN+FP+FN), the required level (FPR≤α) for the false positive rate (FPR) is not necessarily satisfied.

In addition, from the viewpoint of efficiency of inspection work, it is preferable that the false negative rate (FNR) is as low as possible.

The present disclosure has been conceived in view of the above problem. A main objective of the present disclosure is to provide a method for generating a trained model, a determination device, a determination method, and a program that can reduce at least one of a false positive rate or a false negative rate to a predetermined level or lower.

### Solutions to Problems

In order to solve the above problem, a method for generating a trained model of an aspect of the present disclosure is a method for generating a trained model for binary classification, the method comprising: setting, as a hyperparameter, at least one of a weighting parameter or a determination threshold for determining whether the data is positive or negative, the weighting parameter weighting one error in a loss function obtained by adding together an error when training data is positive and an error when the training data is negative more heavily than the other error; performing machine learning on a learning model using the loss function so as to output a probability at which the training data is positive or negative; and searching for the hyperparameter so that at least one of a false positive rate or a false negative rate is equal to or less than a predetermined value. This makes it possible to set at least one of the false positive rate or the false negative rate to a predetermined value or below.

In the above aspect, the loss function may include a corrected probability obtained by correcting the probability output from the learning model by means of the determination threshold. This makes it possible to obtain a threshold suitable for classification.

In the above aspect, the method may comprise: a training step of provisionally setting the determination threshold and training a learning model using the loss function defined by the determination threshold; and a tuning step of determining a tuning determination threshold at which the false positive rate or the false negative rate is equal to or less than a predetermined value from result of classification by the learning model, wherein the training step and the tuning step may be repeatedly performed until the difference between the determination threshold and the tuning determination threshold becomes equal to or less than a predetermined value. This makes it possible to obtain a threshold suitable for classification.

In the above aspect, the method may comprise: setting the weighting parameter that weights an error when the training data is negative in the loss function more heavily than an error when the training data is positive; setting the determination threshold as a predetermined fixed value; and searching for the weighting parameter until the false positive rate becomes equal to or less than a predetermined value. This makes it possible to generate a trained model that guarantees that the false positive rate is equal to or less than a predetermined value. Furthermore, by setting the determination threshold to a fixed value, a common determination threshold can be used even when a plurality of trained models are generated, enabling simplified management. Furthermore, by setting the determination threshold to a fixed value, it is not necessary to search for a determination threshold.

In the above aspect, the searching for the weighting parameter may include increasing the weight each time the weighting parameter is updated. By increasing the weighting each time the weighting parameters are updated, it becomes possible to quickly search for a weighting parameter that will result in a false positive rate equal to or less than a predetermined value.

In the above aspect, the method may comprise: preparing a plurality of the weighting parameters; performing machine learning on a learning model in parallel for the plurality of weighting parameters; and extracting a trained model in which the false positive rate is equal to or less than a predetermined value. By performing machine learning on a learning model in parallel for a plurality of weighting parameters, the number of searches can be reduced.

In the above aspect, when image data is input, the trained model may output a result of pass/fail determination for a product contained in the image data. This makes it possible to determine the pass/fail for the product so that at least one of the false positive rate or the false negative rate is equal to or less than a predetermined value.

A determination device of another aspect of the present disclosure comprises: an acquisition unit that acquires determination data; and a determination unit that determines whether the determination data is positive or negative using a trained model, the trained model generated by setting, as a hyperparameter, at least one of a weighting parameter or a determination threshold for determining whether the data is positive or negative, the weighting parameter weighting one error in a loss function obtained by adding together an error when training data is positive and an error when the training data is negative more heavily than the other error, performing machine learning on a learning model using the loss function so as to output a probability at which the training data is positive or negative, and searching for the hyperparameter so that at least one of a false positive rate or a false negative rate is equal to or less than a predetermined value. This makes it possible to render at least one of the false positive rate or the false negative rate equal to or less than a predetermined value.

In the above aspect, the loss function may include a corrected probability obtained by correcting the probability output from the trained model by means of the determination threshold, and the determination unit may compare a probability at which the determination data is positive or negative output from the trained model with the determination threshold. This makes it possible to obtain a threshold suitable for determination.

In the above aspect, when image data is input as the determination data, the trained model may output a result of pass/fail determination for a product contained in the image data. This makes it possible to determine the pass/fail for a product so as to keep at least one of the false positive rate or the false negative rate equal to or less than a predetermined value.

A determination method of a further aspect of the present disclosure comprises: acquiring determination data; and determining whether the determination data is positive or negative using a trained model, the trained model generated by setting, as a hyperparameter, at least one of a weighting parameter or a determination threshold for determining whether the data is positive or negative, the weighting parameter weighting one error in a loss function obtained by adding together an error when training data is positive and an error when the training data is negative more heavily than the other error, performing machine learning on a learning model using the loss function so as to output a probability at which the training data is positive or negative, and searching for the hyperparameter so that at least one of a false positive rate or a false negative rate is equal to or less than a predetermined value. This makes it possible to render at least one of the false positive rate or the false negative rate equal to or less than a predetermined value.

A program of a further aspect of the present disclosure causes a computer to execute: acquiring determination data; and determining whether the determination data is positive or negative using a trained model, the trained model generated by setting, as a hyperparameter, at least one of a weighting parameter or a determination threshold for determining whether the data is positive or negative, the weighting parameter weighting one error in a loss function obtained by adding together an error when training data is positive and an error when the training data is negative more heavily than the other error, performing machine learning on a learning model using the loss function so as to output a probability at which the training data is positive or negative, and searching for the hyperparameter so that at least one of a false positive rate or a false negative rate is equal to or less than a predetermined value. This makes it possible to set at least one of a false positive rate or a false negative rate to a predetermined value or below.

### Advantageous Effect of Invention

According to the present disclosure, one of the false positive rate and the false negative rate can be reduced to a predetermined value or lower.

### BRIEF DESCRIPTION OF DRAWINGS

FIG. 1 is a diagram showing an example of the configuration of a determination system.

FIG. 2 is a diagram for explaining binary classification.

FIG. 3 is a diagram for explaining an ROC curve.

FIG. 4 is a diagram showing an example of a procedure of a method for generating a trained model.

FIG. 5 is a diagram for explaining a loss function.

FIG. 6 is a diagram for explaining a determination method.

FIG. 7 is a diagram showing an example of a procedure of the determination method.

FIG. 8 is a diagram for explaining an example of a determination result.

FIG. 9 is a diagram showing an example of a procedure of a method for generating a trained model.

FIG. 10 is a diagram for explaining a search for a weighting parameter.

FIG. 11 is a diagram showing an example of a procedure of a determination method.

### DESCRIPTION OF EMBODIMENTS

### First Embodiment

Hereinafter, a first embodiment of the present disclosure will be described with reference to the drawings.

### (System Configuration)

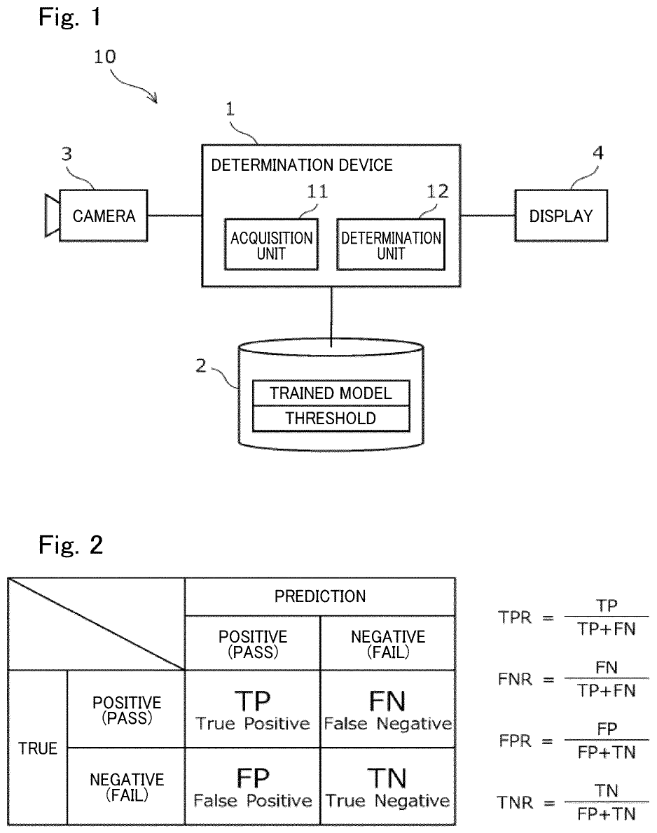

FIG. 1 is a block diagram showing an example of the configuration of a determination system 10. The determination system 10 includes a determination device 1, a storage 2, a camera 3, and a display 4. The determination system 10 is an appearance inspection system that determines the pass/fail of a product imaged by the camera 3 using the determination device 1.

The determination device 1 is a computer including a CPU, a RAM, a ROM, a non-volatile memory, and an input/output interface, etc. The CPU of the determination device 1 executes information processing in accordance with a program loaded from the ROM or the non-volatile memory to the RAM.

The program may be supplied via an information storage medium such as an optical disk or a memory card, or may be supplied via a communication network such as the Internet or a LAN.

The storage 2 is a storage device such as an HDD or an SSD. The storage 2 stores a trained model and a threshold used for determination by the determination device 1. The trained model and the threshold are generated in a learning phase described below.

The camera 3 is a digital camera that captures an image of a product and generates image data. The camera 3 outputs the generated image data to the determination device 1. The display 4 is a display device such as a liquid crystal display. The display 4 outputs the determination result obtained by the determination device 1 to a screen.

The determination device 1 includes an acquisition unit 11 and a determination unit 12. These functional units are implemented by the CPU of the determination device 1 executing information processing in accordance with a program loaded from the ROM or non-volatile memory to the RAM.

The acquisition unit 11 acquires data for determination. Specifically, the acquisition unit 11 acquires image data generated by the camera 3. The image data is an example of data for determination and includes a product to be determined.

The determination unit 12 uses the trained model to determine whether the determination data is positive or negative. Specifically, the determination unit 12 uses the trained model and thresholds stored in the storage 2 to determine the pass/fail of the product included in the image data. Details of the determination will be described later.

The trained model is a trained model for binary classification. In this embodiment, the trained model is, for example, an image discrimination model such as a convolutional neural network (CNN). A deep neural network in which neurons are combined in multiple stages is preferable as the neural network.

When image data is input as determination data, the trained model outputs a determination result of whether the product included in the image data passes or fails. For example, a sigmoid function is used as an output element of the trained model, and a value between 0 inclusive and 1 inclusive that indicates the probability of the product passing or failing is output.

### Objective of the Present Embodiment

Before explaining a method for generating a trained model, an objective of this embodiment will be described.

In an inspection to determine whether a product is acceptable or not, a failing product may be judged as acceptable (false positive, that is FP) or a passing product may be judged as unacceptable (false negative, that is FN) (see FIG. 2). In order to guarantee quality, it is necessary to reduce the false positive rate (FPR), but if the false positive rate (FPR) is reduced, there is a risk that the false negative rate (FNR) will increase.

Thus, in this embodiment, from the viewpoint of quality assurance, it is an objective to suppress the false positive rate (FPR) to a predetermined value a₁ or less, and also to suppress the false negative rate (FNR) as much as possible.

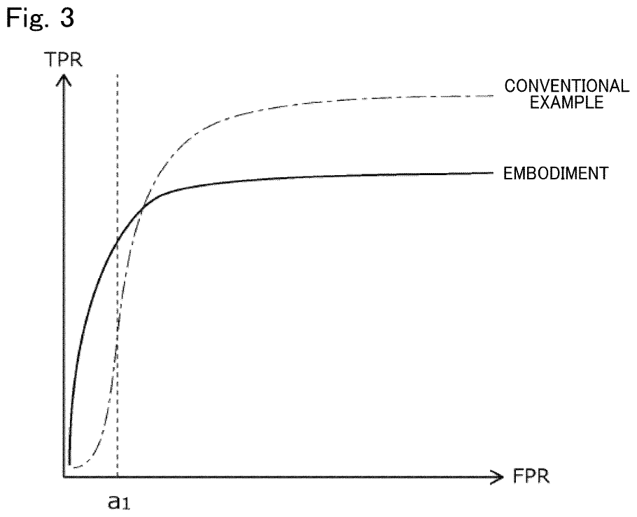

To explain this using the receiver operating characteristic (ROC) curve in FIG. 3, in the conventional example, the true positive rate (TPR) may be insufficient in the range of FPR≤a₁. It is therefore an objective of this embodiment to improve the true positive rate (TPR) as much as possible in the range of FPRS≤a₁, that is, to suppress the false negative rate (FNR) as much as possible.

### (Learning Phase)

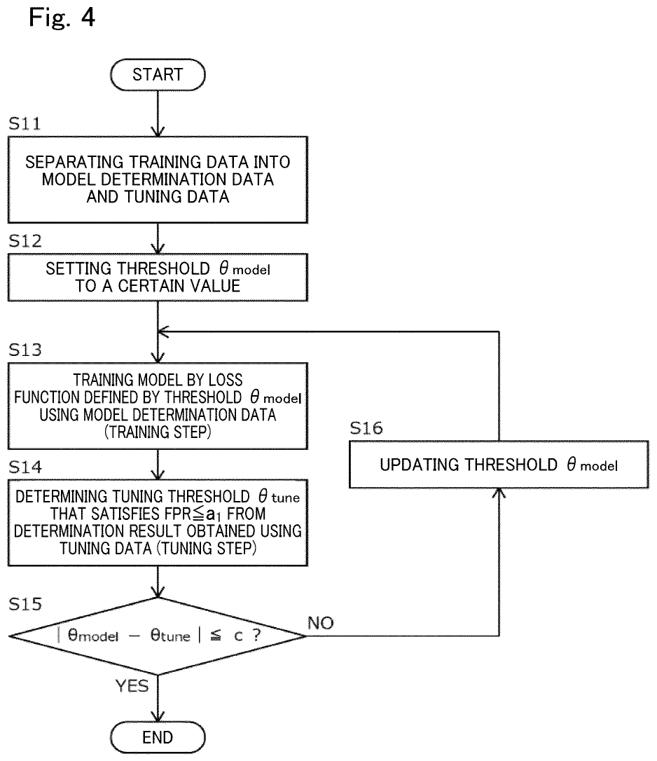

A method for generating a trained model by machine learning will be described below. FIG. 4 is a flow diagram showing an example of a procedure for a method for generating a trained model. Each step shown in the diagram is implemented by information processing by a computer.

If a model is trained to guarantee FPR≤a₁, the TNR tends to be high. Therefore, in this embodiment, in order to preferentially improve the TPR, that is, to preferentially suppress the FNR, the model is trained using a loss function in which the error when the training data is pass (positive) is weighted more heavily than the error when the training data is fail (negative).

In this embodiment, in order to obtain an appropriate threshold θ that achieves the above objective, the loss function includes a corrected probability obtained by correcting the probability of passing (positive) or failing (negative) in accordance with the relationship with a given threshold θ. The threshold θ is a threshold for determining fail (negative) (a threshold 1−θ is a threshold for determining pass (positive)). Details of the loss function will be described later.

As shown in FIG. 4, first, training data is separated into model parameter training data and tuning data (S11). The training data is a data set in which training images are correlated with pass/fail labels.

The training data may further include validation data for validating the accuracy of the model. For example, 80% of the training data may be model parameter training data, 10% may be tuning data, and 10% may be validation data (overlearning evaluation data).

Next, a threshold θ_{model} is provisionally set to a certain value (S12). The threshold θ_{model} may be defined, for example, as a positive constant multiple of a value based on a weighting coefficient in a loss function, as described later.

A training step is executed using model parameter training data (S13). At the training step, the model is trained using a loss function defined by the provisionally set threshold θ_{model}.

The model is trained by calculating a loss function from the pass/fail probability obtained when training images are input into the model and the pass/fail labels correlated with the training images, and updating the model parameters to minimize the loss function.

A tuning step is then executed using tuning data (S14). At the tuning step, a tuning threshold θₜᵤₙₑ that satisfies FPR≤a₁ is determined from the model determination result.

The model determination result is the pass/fail probability obtained by inputting the training image of the tuning data into the model. Based on the obtained pass/fail probability and the pass/fail label correlated with the training image, the boundary of the probability that satisfies FPR≤a₁ can be obtained as the tuning threshold θₜᵤₙₑ.

It is then determined whether the difference between the threshold θ_{model} and the tuning threshold θₜᵤₙₑ is equal to or less than a predetermined value c (S15). If the difference between the threshold θ_{model} and the tuning threshold θₜᵤₙₑ exceeds the predetermined value c (S15: NO), the threshold θ_{model} is updated (S16), and the training step (S13) and the tuning step (S14) are again executed.

Since the threshold θ_{model} is a hyperparameter and cannot be searched for by a loss function, the threshold θ_{model} is updated by, for example, a bisection method. Specifically, (θ_{model}+θₜᵤₙₑ)/2 is used as a new threshold θ_{model}. For example, as described later, a lower limit value at which FNR monotonically decreases with respect to θ is estimated, and θ equal to or greater than the lower limit value is searched for by the bisection method based on the monotonically decreasing nature of FNR.

The training step (S13) and the tuning step (S14) are repeatedly performed until the difference between the threshold θ_{model} and the tuning threshold θₜᵤₙₑ becomes equal to or less than the predetermined value c, that is, until the threshold θ_{model} approaches the tuning threshold θₜᵤₙₑ within a proper range.

If the difference between the threshold θ_{model} and the tuning threshold θₜᵤₙₑ becomes equal to or less than the predetermined value c (S15: YES), the model determination accuracy, FPR, FNR, etc. are confirmed using the verification data, and then all the steps are terminated. This makes it possible to obtain a trained model that can achieve FPR≤a₁ while suppressing FNR, and a threshold θ proper for pass/fail determination.

### (Loss Function)

The loss function used at the training step (S13) will be described below.

As described above, in this embodiment, a loss function is used that can weight the error when the training data is pass (positive) more than the error when the training data is fail (negative). For example, binary cross entropy (BCE) with logistic loss, which allows such weighting, is used as the loss function (see Formula 1).

$$l = - [ p \cdot y \cdot log σ ( x ) + ( 1 - y ) \cdot log ( 1 - σ ( x ) ) ] \qquad ( Formula 1 )$$

p is a weighting coefficient, and the first term can be weighted by selecting a value greater than 1. If a value less than 1 is selected for p, the second term can be weighted. p is a hyperparameter and cannot be searched for using this loss function, so that an appropriate value that satisfies the conditions described below may be set. x is the output value of a model, and σ(x) is the probability of predicting pass (positive). The first term in the square brackets of Formula 1 represents the error when the training data is pass (positive), and the second term represents the error when the training data is fail (negative). The weighting coefficient p is included in the first term. In this loss function, the loss is configured to be greater the more the model prediction is a class (i.e., FP or FN) different from the correct answer, and when p is a value greater than 1, the loss is greater the more the predicted class is FN.

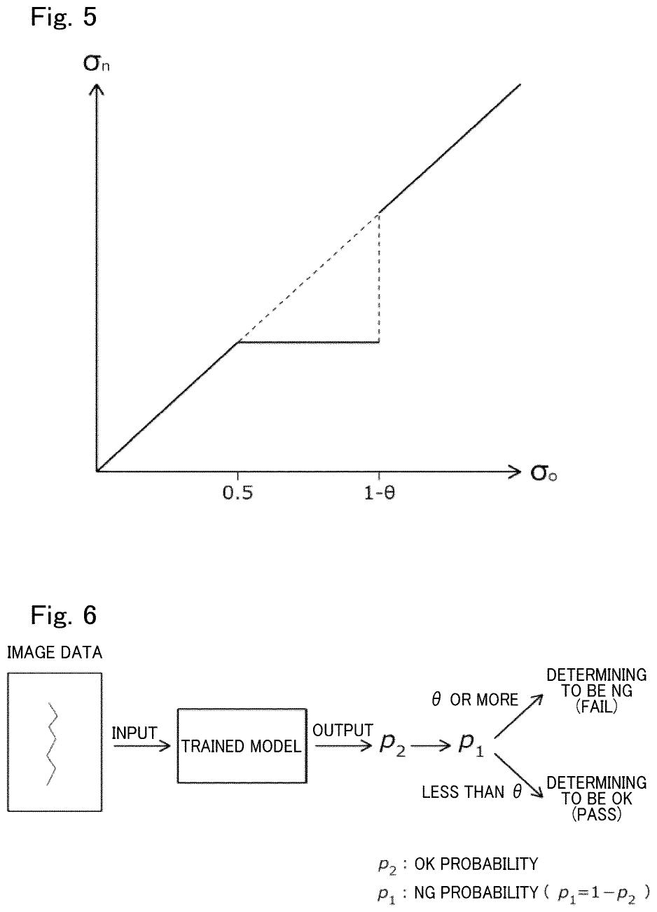

The determination for the threshold θ is defined as shown in Formula 2 (see FIG. 5), where σ₀ is the probability that y=1 (pass) and 1−σ₀ is the probability that y=0 (fail). Here, the threshold θ is a threshold for determining fail (negative) and that the threshold 1−θ is a threshold for determining pass (positive).

$${σ}_{n} ( θ ) = \{ \begin{matrix}{σ}_{0} & ( 1 - θ < {σ}_{0} ) \\ 0.5 & ( 0.5 < {σ}_{0} < 1 - θ ) \\ {σ}_{0} & ( {σ}_{0} < 0.5 )\end{matrix} \qquad ( Formula 2 )$$

σₙ(θ) is a corrected probability obtained by correcting σ₀ depending on the relationship with the threshold θ. σₙ(θ) is discontinuous anterior and posterior to the threshold 1−θ.

If the weighting coefficient p is such that the difference in the loss function is 1(θ+Δθ)−1(θ)<0 at a certain θ, Δθ>0, the FNR will decrease monotonically. When y=1, this is expressed by Formula 3, and when y=0, this is expressed by Formula 4.

$$\begin{matrix}l ( θ + Δθ ) - l ( θ ) = - p log \frac{{σ}_{n} ( θ + Δθ )}{{σ}_{n} ( θ )} \\ = \{ \begin{matrix}0 & ( 1 - θ < {σ}_{0} ) \\ - p log \frac{{σ}_{0}}{0.5} & ( 1 - θ - Δθ < {σ}_{0} < 1 - θ ) \\ 0 & ( {σ}_{0} < 1 - θ - Δθ )\end{matrix} \\ = \{ \begin{matrix}- p log \frac{{σ}_{0}}{0.5} & ( 1 - θ - Δθ < {σ}_{0} < 1 - θ ) \\ 0 & ( other than the above )\end{matrix}\end{matrix} \qquad ( Formula 3 )$$

$$l ( θ + Δθ ) - l ( θ ) = \{ \begin{matrix}- log \frac{1 - {σ}_{0}}{0.5} & ( 1 - θ - Δθ < {σ}_{0} < 1 - θ ) \\ 0 & ( other than the above )\end{matrix} \qquad ( Formula 4 )$$

Hence, the difference in the loss function caused by changing @ occurs only in the vicinity of or σ₀˜1−θ. Normally, since N_{y=1}>N_{y=0}, it can be assumed that the number of pass (positive) cases and the number of fail (negative) cases for or σ₀˜1−θ are the same. Thus, the condition for the weighting coefficient p that causes the loss function to decrease monotonically is expressed by Formula 5.

$$\frac{log \frac{θ}{0.5}}{log \frac{0.5}{1 - θ}} > p \qquad ( Formula 5 )$$

Based on this formula, it is possible to confirm the numerical range that the threshold θ should satisfy.

### (Inference Phase)

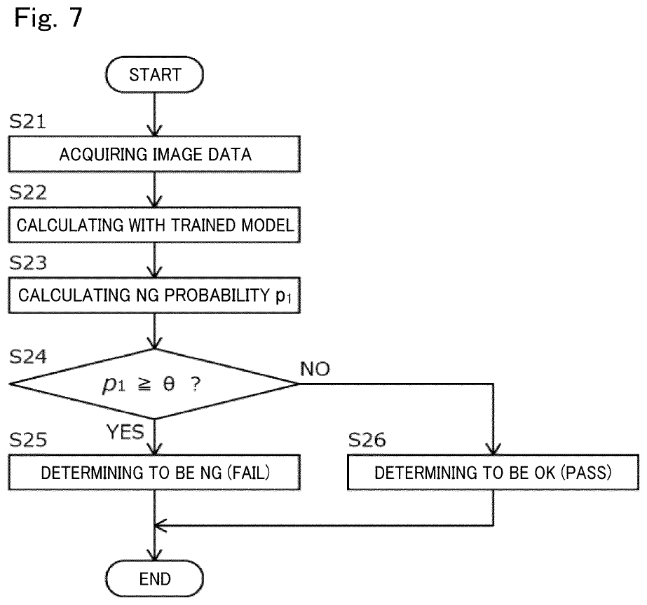

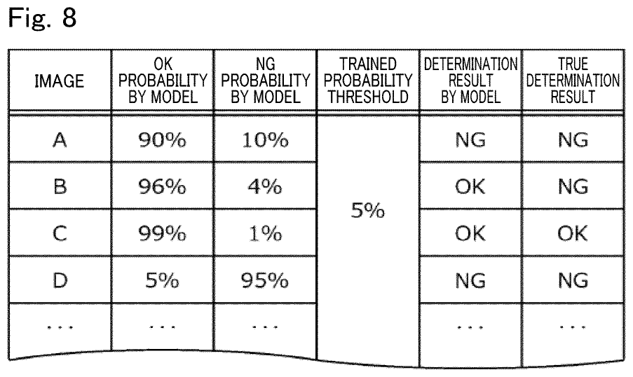

Hereinafter, a determination method using a trained model generated in the learning phase and a threshold θ, which is implemented in the determination system 10 (see FIG. 1), will be described. FIG. 6 is a diagram for explaining the determination method. FIG. 7 is a flow diagram showing an example of a procedure of a determination method. FIG. 8 is a diagram for explaining an example of a determination result. The determination device 1 functions as the acquisition unit 11 and the determination unit 12 by executing information processing of FIG. 6 in accordance with a program.

First, the determination device 1 acquires image data captured by the camera 3 (S21: functioning as the acquisition unit 11).

The determination device 1 then determines whether a product contained in the image data is OK (pass) or NG (fail) using the trained model and threshold θ that are generated in the learning phase and stored in the storage 2 (see FIG. 1) (S22-S26: functioning as the determination unit 12).

Specifically, the determination device 1 inputs the image data into the trained model and calculates an OK probability p₂ at which the product is OK (pass) (S22). The output element of the trained model is configured as a sigmoid function, and the OK probability p₂ is output as a value of 0 or more and 1 or less.

The determination device 1 then calculates an NG probability p₁ at which the product is NG (fail) from the OK probability p₂ (S23). The NG probability p₁ is expressed as 1−p₂. The OK probability p₂ or the NG probability p₁ is an example of a determination result of the pass/fail of the product contained in the image data.

The determination device 1 then compares the NG probability p₁ with the threshold θ and determines whether the NG probability p₁ is equal to or greater than the threshold θ (S24).

If the NG probability p₁ is equal to or greater than the threshold θ (S24: YES), the determination device 1 determines that the product is NG (fail) (S25).

If the NG probability p₁ is less than the threshold θ (S24: NO), the determination device 1 determines that the product is OK (pass) (S26).

As shown in the example of FIG. 8, when the threshold θ is 5%, images A and D, whose NG probability p₁ is 5% or more, are determined to be NG (fail), and images B and C, whose NG probability p₁ is less than 5%, are determined to be OK (pass). According to the first embodiment described above, in an inspection for determining whether a product contained in image data is OK (pass) or NG (fail), it is possible to suppress the FNR while achieving FPR≤a₁.

### (Modification)

In the first embodiment described above, the objective was to suppress the false positive rate (FPR) to a predetermined value a₁ or less while also suppressing the false negative rate (FNR). However, conversely, the objective may be to suppress the false negative rate (FNR) to a predetermined value b₁ or less while also suppressing the false positive rate (FPR).

If a model is trained to guarantee FNR≤b₁, the TPR tends to be high. Thus, in this modification, in order to preferentially improve the TNR, i.e., to preferentially suppress the FPR, the model is trained using a loss function in which the error when the training data is fail (negative) is weighted more heavily than the error when the training data is pass (positive).

Specifically, in the loss function expressed by the above formula 1, the weighting coefficient p is included not in the first term but in the second term in square brackets that represents the error when the training data is fail (negative).

In the training step (S13), the model is trained using such a loss function. In the tuning step (S14), the tuning threshold θₜᵤₙₑ that satisfies FNR≤b₁ is obtained from the model determination result.

Although the first embodiment of the present disclosure has been described above, the present disclosure is not limited to the above-described embodiment, and various modifications can be made by those skilled in the art.

In the above embodiment, image data is used as the determination data, but the determination data is not limited thereto, and various types of data can be used as the determination data.

In the above embodiment, the NG probability p₁ is calculated and compared with the threshold θ for determining NG (fail), but this is not limitative, and the OK probability p₂ may be calculated and compared with the threshold 1−θ for determining OK (pass).

Alternatively, a model may be trained so that the FNR becomes equal to or less than a predetermined value using a loss function in which the error when the training data is pass (positive) is weighted more heavily than the error when the training data is fail (negative).

In addition, a model may be trained so that the FPR becomes equal to or less than a predetermined value using a loss function in which the error when the training data is fail (negative) is weighted more heavily than the error when the training data is pass (positive).

### Second Embodiment

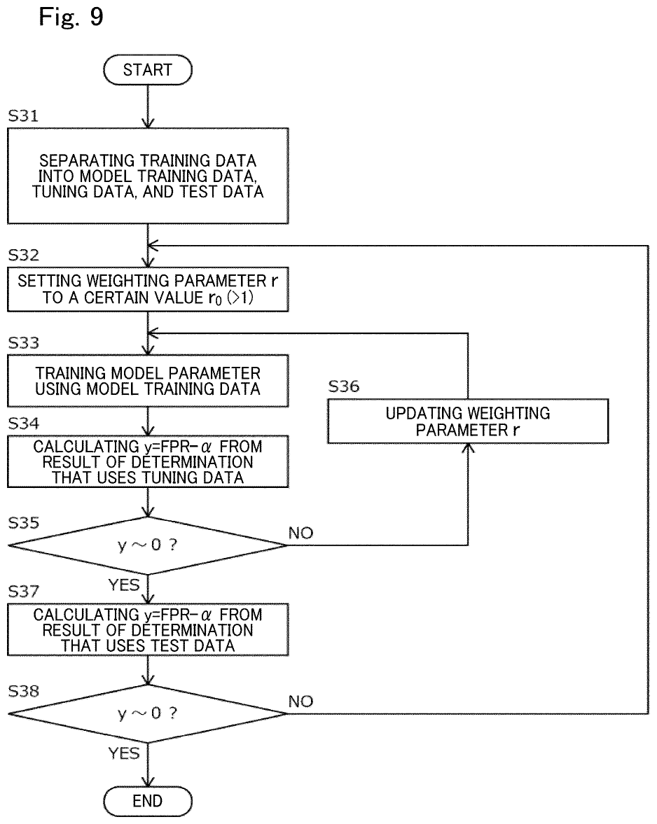

A second embodiment will be described below. FIG. 9 is a flow diagram showing an example of a procedure of a trained model generation method according to the second embodiment. Steps shown in the diagram are each implemented by information processing by a computer.

In the second embodiment, a weighting parameter r, which weights the error when the training data is fail (negative) more heavily than the error when the training data is pass (positive) in the loss function, is set as a hyperparameter, and the determination threshold θ is set as a predetermined fixed value. Then, machine learning of the learning model is performed using the loss function, and the weighting parameter r is searched for until the FPR becomes equal to or less than a predetermined value α.

As shown in FIG. 9, first, the training data is separated into model training data, tuning data, and test data (S31). The training data is a data set in which each of training images is associated with pass/fail label. For example, 80% of the training data may be model training data, 10% may be tuning data, and 10% may be test data (overlearning evaluation data).

The weighting parameter r is then set to a value r₀(S32). r₀ is a value greater than 1.

A model parameter is then trained using the model training data (S33). Specifically, training is performed based on a loss function including a weighting parameter r that weights the error when the training data is fail (negative) more heavily than the error when the training data is pass (positive), so that a trained parameter kᵣ (the hat is omitted in the text) can be obtained. The trained parameter kᵣ is expressed by the following Formula 6.

$$( Formula 6 )$$

$${\hat{k}}_{r} = {arg min}_{k} ( - \frac{1}{{l}_{1}} {\sum }_{l ∈ {D}_{T}} {Y}_{l} log ( {p}_{l} ( k ) ) - \frac{r}{{l}_{θ}} {\sum }_{l ∈ {D}_{T}} ( 1 - {Y}_{l} ) log ( 1 - {p}_{l} ( k ) ) )$$

Here, D_{T} represents total training data. r is a weighting parameter and is a value greater than 1. Y₁ is a pass/fail label of the training data (1: pass, 0: fail). p₁(k) is a predicted value (probability) at which data l is determined to be Y=1 (pass) or Y=0 (fail).

l₀ is the number of failing (negative) training data, and l₁ is the number of passing (positive) training data. Since it is difficult to prepare equal number of passing training data and failing training data, the weights l₀ and l₁ of the number of data are adopted to suppress the influence of the bias.

This formula 6 is configured such that the loss becomes relatively large when the prediction deviates in the case where the training data is fail, by setting the weighting parameter r to a value greater than 1. Hence, under this loss function, training is performed to minimize the FPR.

At S32 and S33, the weighting parameter r=r₀ is set, and then model parameters are trained using the model training data to obtain a trained parameter kᵣₒ.

The value of y for FPR confirmation is calculated from the result of determination using the tuning data by the model including the trained parameter kᵣₒ (S34). y is expressed by the following Formula 7.

$$y = FPR ( {\hat{k}}_{r 0} ) - α \qquad ( Formula 7 )$$

Here, FPR is an FPR calculated from the determination result by the model including the trained parameter kᵣₒ. α is a preset value that is appropriately selected based on the FPR level required for the model.

It is then determined whether the value of y can be approximately regarded as 0 (S35). Specifically, it is determined whether the value of y is within a predetermined range inclusive of 0.

If the value of y cannot be regarded as approximately 0 (S35: NO), the weighting parameter r is updated (S36), and the model parameter training (S33) and the y-value calculation (S34) are again performed.

In this manner, the weighting parameter r is searched for by repeatedly performing the processes of S33 to S36. The weighting parameter r is searched for until the value of y can be regarded as approximately 0 (S35: YES), that is, until the FPR becomes equal to or less than a predetermined value.

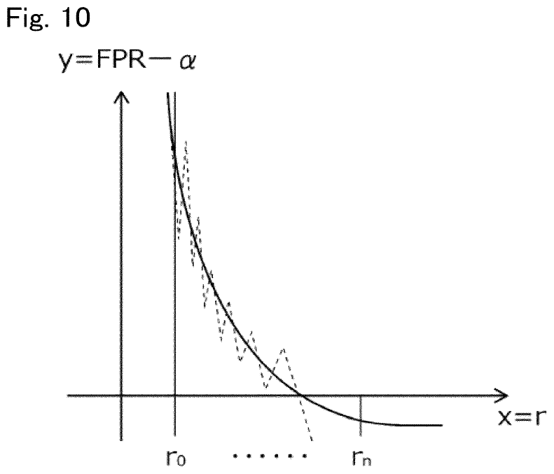

The weighting parameter r is searched for by using, for example, a technique such as a linear search method. As shown by the solid line in FIG. 10, it is expected that the value of y will generally tend to decrease as the weighting parameter r increases, so that it is preferable to increase the weighting every time the weighting parameter r is updated.

However, as shown by the broken line in FIG. 10, since the value of y often fluctuates in actual training due to fluctuations in data selection, etc., the weighting parameter r may be determined by preparing a plurality of weighting parameters r and comparing the values of y after training them in parallel. In this case, it is expected that the number of search loops can be reduced.

In addition, if the weighting parameter r is made too large, the influence of the first term of the loss function becomes relatively small and the FNR tends to increase, so that it is desirable to keep the weighting parameter r at a minimum value within a range that satisfies FPR≤α and suppress the increase in the FNR. This makes it possible to suppress the FNR while ensuring FPR≤α.

If the value of y can be regarded as approximately 0 (S35: YES), a similar verification is performed using the trained parameter kᵣ obtained by the search. That is, the value of y is again calculated from the determination result obtained by using the test data (S37), to determine whether the value of y can be regarded as approximately 0 (S38).

If the value of y can be regarded as approximately 0 (S38: YES), the search ends. In this case, it is preferable to compare with a value less than that at S35 above. For example, if it is determined at S35 above that the value of y is 0 or less, it is preferable to determine at S38 whether the value of y is equal to or less than a value a (e.g., a=−0.01) slightly less than 0.

If the value of y cannot be regarded as approximately 0 (S38: NO), the processes of S32 to S36 are repeatedly preformed.

By the above procedure, it is possible to obtain a trained model that has an excellent balance between FPR and FNR, while ensuring that FPR≤α and suppressing FNR.

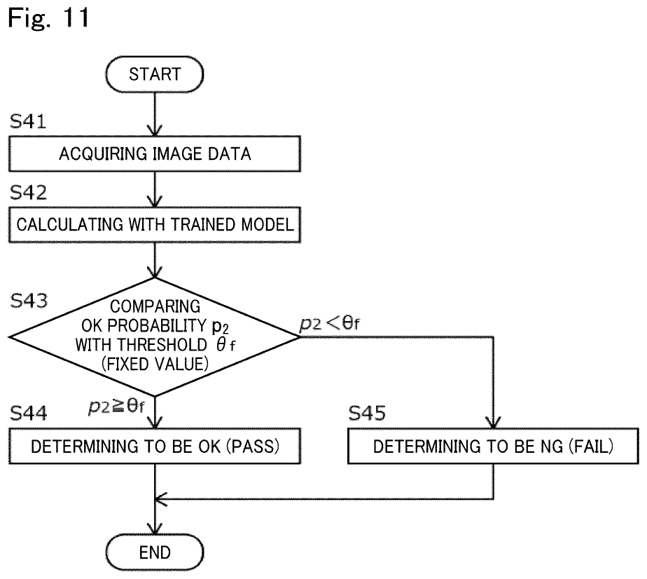

FIG. 11 is a diagram showing an example of a procedure of a determination method according to the second embodiment using a trained model generated by the trained model generation method according to the second embodiment. The determination device 1 executes information processing of the diagram in accordance with a program.

First, the determination device 1 acquires image data captured by the camera 3 (S41: functioning as the acquisition unit 11).

The determination device 1 then uses the trained model to determine whether the product contained in the image data is OK (pass) or NG (fail) (S42-S45: functioning as the determination unit 12).

Specifically, the determination device 1 inputs the image data into the trained model and calculates the OK probability p₂ at which the product is OK (pass) (S42). The output element of the trained model is configured as a sigmoid function, and the OK probability p₂ is output as a value equal to or greater than 0 and equal to or less than 1.

The determination device 1 then compares the OK probability p₂ with a determination threshold θ_{f} and determines whether the OK probability p₂ is equal to or greater than the determination threshold θ_{f}(S43). In the second embodiment, the determination threshold θ_{f} is a predetermined fixed value.

If the OK probability p₂ is equal to or greater than the determination threshold θ_{f} at S43, the determination device 1 determines that the product is OK (pass) (S44).

If the OK probability p₂ is less than the determination threshold Or at S43, the determination device 1 determines that the product is NG (fail) (S45).

Here, the determination is made by comparing the OK probability p₂ with the determination threshold θ_{f}, but this is not limitative, and the determination may be made by comparing the NG probability p₁ with the determination threshold 1−θ_{f}, as in the first embodiment.

### (Summary of Aspects)

As is apparent from the above description, the present disclosure includes aspects below. In the following, reference numerals are given in parentheses only to clarify the correspondence with the embodiments.

(Aspect 1) A method for generating a trained model according to the present disclosure is:
a method for generating a trained model for binary classification, comprising:
setting, as a hyperparameter, at least one of a weighting parameter or a determination threshold for determining whether the data is positive or negative, the weighting parameter weighting one error in a loss function obtained by adding together an error when training data is positive and an error when the training data is negative more heavily than the other error;
performing machine learning on a learning model using the loss function so as to output a probability at which the training data is positive or negative; and
searching for the hyperparameter so that at least one of a false positive rate or a false negative rate is equal to or less than a predetermined value.

(Aspect 2) In the method for generating a trained model of aspect 1, the loss function may include a corrected probability obtained by correcting the probability output from the learning model by means of the determination threshold.

(Aspect 3) The method for generating a trained model of aspect 2 may comprise:
a training step of provisionally setting the determination threshold and training a learning model using the loss function defined by the determination threshold; and
a tuning step of determining a tuning determination threshold at which the false positive rate or the false negative rate is equal to or less than a predetermined value from result of classification by the learning model,
wherein the training step and the tuning step may be repeatedly performed until the difference between the determination threshold and the tuning determination threshold becomes equal to or less than a predetermined value.

(Aspect 4) The method for generating a trained model of any one of aspects 1 to 3 may comprise:
setting the weighting parameter that weights an error when the training data is negative in the loss function more heavily than an error when the training data is positive;
setting the determination threshold as a predetermined fixed value; and
searching for the weighting parameter until the false positive rate becomes equal to or less than a predetermined value.

(Aspect 5) In the method for generating a trained model of aspect 4, the searching for the weighting parameter may include increasing the weight each time the weighting parameter is updated.

(Aspect 6) The method for generating a trained model of aspect 4 or 5 may comprise:
preparing a plurality of the weighting parameters;
performing machine learning on a learning model in parallel for the plurality of weighting parameters; and
extracting a trained model in which the false positive rate is equal to or less than a predetermined value.

(Aspect 7) In the method for generating a trained model of any one of aspects 1 to 6, the trained model may output a result of pass/fail determination for a product contained in image data when the image data is input.

(Aspect 8) A determination device (1) according to the present disclosure comprises:
an acquisition unit (11) that acquires determination data; and
a determination unit (12) that determines whether the determination data is positive or negative using a trained model, the trained model generated by setting, as a hyperparameter, at least one of a weighting parameter or a determination threshold for determining whether the data is positive or negative, the weighting parameter weighting one error in a loss function obtained by adding together an error when training data is positive and an error when the training data is negative more heavily than the other error, performing machine learning on a learning model using the loss function so as to output a probability at which the training data is positive or negative, and searching for the hyperparameter so that at least one of a false positive rate or a false negative rate is equal to or less than a predetermined value.

(Aspect 9) In the determination device (1) of aspect 8,
the loss function may include a corrected probability obtained by correcting the probability output from the trained model by means of the determination threshold, and
the determination unit may compare a probability at which the determination data is positive or negative output from the trained model with the determination threshold.

(Aspect 10) In the determination device (1) of aspect 8 or 9, when image data is input as the determination data, the trained model may output a result of pass/fail determination for a product contained in the image data.

(Aspect 11) A determination method according to the present disclosure comprises:
acquiring determination data; and
determining whether the determination data is positive or negative using a trained model, the trained model generated by setting, as a hyperparameter, at least one of a weighting parameter or a determination threshold for determining whether the data is positive or negative, the weighting parameter weighting one error in a loss function obtained by adding together an error when training data is positive and an error when the training data is negative more heavily than the other error, performing machine learning on a learning model using the loss function so as to output a probability at which the training data is positive or negative, and searching for the hyperparameter so that at least one of a false positive rate or a false negative rate is equal to or less than a predetermined value.

(Aspect 12) A program according to the present disclosure causes a computer to execute:
acquiring determination data; and
determining whether the determination data is positive or negative using a trained model, the trained model generated by setting, as a hyperparameter, at least one of a weighting parameter or a determination threshold for determining whether the data is positive or negative, the weighting parameter weighting one error in a loss function obtained by adding together an error when training data is positive and an error when the training data is negative more heavily than the other error, performing machine learning on a learning model using the loss function so as to output a probability at which the training data is positive or negative, and searching for the hyperparameter so that at least one of a false positive rate or a false negative rate is equal to or less than a predetermined value.

### CROSS-REFERENCE TO RELATED APPLICATIONS

This application claims priority to Japanese Patent Application No. 2022-126088 filed to Japan Patent Office on Aug. 8, 2022, the contents of which are incorporated herein by reference in its entirety. This application claims priority to Japanese Patent Application No. 2022-182474 filed to Japan Patent Office on Nov. 15, 2022, the contents of which are incorporated herein by reference in its entirety.

### REFERENCE SIGNS LIST

1 determination device, 2 storage, 3 camera, 4 display, 10 determination system, 11 acquisition unit, 12 determination unit

1. A method for generating a trained model for binary classification, performed by a processor, comprising:
setting, as a hyperparameter, at least one selected from a group consisting of a weighting parameter and a determination threshold for determining whether the data is positive or negative, the weighting parameter weighting one error in a loss function obtained by adding together an error when training data is positive and an error when the training data is negative more heavily than the other error;
performing machine learning on a learning model using the loss function so as to output a probability at which the training data is positive or negative; and
searching for the hyperparameter so that at least one selected from a group consisting of a false positive rate and a false negative rate is equal to or less than a predetermined value.

2. The method for generating a trained model according to claim 1,
wherein the loss function includes a corrected probability obtained by correcting the probability output from the learning model by means of the determination threshold.

3. The method for generating a trained model according to claim 2, comprising:
a training step of provisionally setting the determination threshold and training a learning model using the loss function defined by the determination threshold; and
a tuning step of determining a tuning determination threshold at which the false positive rate or the false negative rate is equal to or less than a predetermined value from result of classification by the learning model,
wherein the training step and the tuning step are repeatedly performed until the difference between the determination threshold and the tuning determination threshold becomes equal to or less than a predetermined value.

4. The method for generating a trained model according to claim 1, comprising:
setting the weighting parameter that weights an error when the training data is negative in the loss function more heavily than an error when the training data is positive;
setting the determination threshold as a predetermined fixed value; and
searching for the weighting parameter until the false positive rate becomes equal to or less than a predetermined value.

5. The method for generating a trained model according to claim 4,
wherein the searching for the weighting parameter includes increasing the weight each time the weighting parameter is updated.

6. The method for generating a trained model according to claim 4, comprising:
preparing a plurality of the weighting parameters;
performing machine learning on a learning model in parallel for the plurality of weighting parameters; and
extracting a trained model in which the false positive rate is equal to or less than a predetermined value.

7. The method for generating a trained model according to claim 1,
wherein the trained model outputs a result of pass/fail determination for a product contained in image data when the image data is input.

8. A determination device comprising,
a processor configured to:
acquire determination data; and
determine whether the determination data is positive or negative using a trained model, the trained model generated by setting, as a hyperparameter, at least one selected from a group consisting of a weighting parameter and a determination threshold for determining whether the data is positive or negative, the weighting parameter weighting one error in a loss function obtained by adding together an error when training data is positive and an error when the training data is negative more heavily than the other error, performing machine learning on a learning model using the loss function so as to output a probability at which the training data is positive or negative, and searching for the hyperparameter so that at least one selected from a group consisting of a false positive rate and a false negative rate is equal to or less than a predetermined value.

9. The determination device according to claim 8,
wherein the loss function includes a corrected probability obtained by correcting the probability output from the trained model by means of the determination threshold, and
wherein the processor is further configured to compare a probability at which the determination data is positive or negative output from the trained model with the determination threshold.

10. The determination device according to claim 8,
wherein when image data is input as the determination data, the trained model outputs a result of pass/fail determination for a product contained in the image data.

11. A determination method performed by a processor, comprising:
acquiring determination data; and
determining whether the determination data is positive or negative using a trained model, the trained model generated by setting, as a hyperparameter, at least one selected from a group consisting of a weighting parameter and a determination threshold for determining whether the data is positive or negative, the weighting parameter weighting one error in a loss function obtained by adding together an error when training data is positive and an error when the training data is negative more heavily than the other error, performing machine learning on a learning model using the loss function so as to output a probability at which the training data is positive or negative, and searching for the hyperparameter so that at least one selected from a group consisting of a false positive rate and a false negative rate is equal to or less than a predetermined value.

12. (canceled)
